(19) United States
(12) Patent Application Publication
(10) Pub. No.: US 2010/0162599 A1
(43) Pub. Date: Jul. 1, 2010

(54) Flame Effect Fire

(76) Inventors: Noel O'Neill, Louth (IE); Joseph FitzGerald, Westmeath (IE)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 12/086,505

(22) PCT Filed: Dec. 14, 2006
(86) PCT No.: PCT/EP2006/069712

§ 371 Date: Sep. 24, 2008

(30) Foreign Application Priority Data
Dec. 14, 2005 (GB) 0525420.6

(51) Int. Cl. G09F 19/00; B23P 11/00

(52) U.S. Cl. 40/427; 29/428

(57) ABSTRACT

A flame effect assembly is described. By using an adhesive to secure a fabric to at least one track and then defining a plurality of flag elements within the fabric by forming two or more slits in the fabric it is possible to substantially optimise the assembly process.

### FIELD OF THE INVENTION

The present invention relates to electric fires and in particular to an electric fire that utilises a fabric to simulate the flame effect. The invention particularly relates to an improved method of providing the fabrics within the fire and to a fire incorporating such fabrics.

### BACKGROUND OF THE INVENTION

Electric fires are known in the art. Initially introduced to replace the traditional fireplace, they were dimensioned so as to fit into the hearth of the fireplace. They are advantageous over the traditional fire based on combustible fuels in that the heat is immediate on turning on the fire and there is no cleaning required. Some of the earlier models included two or more elements that could be selectively activated to determine the amount of heat output. These were often situated in the bottom portion of the fire, and had a coal effect plastic moulding provided thereabove, which could be backlit so as to provide the coal effect.

With developments in the fire it is known to provide one or more fabric pieces that are hung vertically above the fuel bed and which when blown from below using an air blower would move, thereby simulating the flickering effect of flames.

An example of use of such ribbons is found in GB2404730 which discloses individually hanging the vertical ribbons with alternate ribbons off-set forward of adjacent ribbons such that they overlap.

Problems associated with all these known flame effect include the fact that the individual ribbons need to be hung separately within the fire. This is a cumbersome process and is difficult to ensure consistent effects. There is therefore a need to provide an improved method for providing such flame effects within a fire.

### SUMMARY

Accordingly, these and other needs are addressed by methods and assemblies of the invention which provide for a flag assembly manufactured in a consistent manner which obviates the need for individually attaching the fabrics with a fire.

A first embodiment provides a method of manufacturing a flag assembly for use in an electric fire, the method comprising:
Providing a roll of fabric,
Providing a first track,
Attaching a portion of the fabric to the first track so as to fix the fabric to the track, and
Providing a plurality of slits in the adhered fabric, the plurality of slits defining a plurality of flag elements.

In such an embodiment the fabric is attachment of the portion of the fabric may be achieved by adhesively adhering or affixing the fabric in some other suitable fashion at one end only to a supporting track. A modification to this arrangement may be where the providing the first track includes providing a second track, and wherein the step of attaching the fabric fixes the fabric to the first and second tracks such that the fabric is fixed to and separates the first and second tracks.

The adhesive adherence of the fabric to the respective tracks, where used, may be effected by providing an adhesive surface on a first surface of each of the tracks and applying that adhesive surface onto the fabric so as to secure the fabric onto the tracks.

The tracks are typically initially provided as two individual coils that are unwound at an unwind station to provide respective tracks during the collation process.

In such an arrangement an adhesive surface is desirably provided by applying an adhesive tape on the track prior to coiling the track to form the coil, the tape having a protective cover on an outermost surface which is removed during the uncoiling of the track from the coil. Alternatively, an adhesive may be applied to the individual tracks during the uncoiling process.

The tracks are typically formed from a metal, such as nickel plated mild steel or hot dipped galvanised steel.

The method may include a punching of segments of the individual tracks so as to form portions of the tracks which stand proud of the surface of the tracks. Such punching processes may result in a change in orientation of the fabric secured to these segments. It will be understood that such a punching achieves a change in planar orientation of adjacent portions of the track relative to one another.

The segments of the track are typically punched or pushed so as to be substantially perpendicular to the main axis of the track.

Once an assembly has been fabricated, individual flag inserts may be formed by cutting the assembly to one or more desired lengths.

Each of the flag inserts are desirably dimensioned to fit within a predefined area within an electric fire. The inserts are typically hung within the fire using a first track to secure the insert within the fire, the fabric attached thereto hang from the track under the effect of gravity.

According to another aspect, the invention provides a flag assembly for use in a flame effect fire, the flag assembly comprising fabric fixed to a track to define a first portion of fabric fixed to the track, and a second portion of fabric depending from the track, wherein the second portion of fabric is cut to define a plurality of slits therein, the slits forming two or more flag elements within the fabric.

The fabric may be adhered to a first surface of the track in a first plane and one or more second surfaces of the track in a second plane.

The assembly may include a second track fixed to the fabric, typically through use of an adhesive, the first and second tracks being separated from one another by the fabric. In such an arrangement, the fabric is adhered to a first surface of the second track in a first plane and one or more second surfaces of the second track in a second plane

The first and second planes may be substantially perpendicular to one another.

The slits may be defined at locations coincident with the location of the second surfaces.

The second surface may comprise a segment of the track which is punched or pushed to stand proud of the main axis of the track.

The second surfaces are typically spaced apart along the longitudinal axis of the track. The second surfaces on the first and second tracks may be oppositely located,

The fabric may be a continuous length of fabric and may be typically drawn from a roll. The fabric is typically fixed to the track at a first longitudinal side edge thereof. The longitudinal axis of the fabric typically runs substantially parallel to the longitudinal axis of the track to which it is fixed.

In an alternative embodiment the invention provides a flag assembly for use in a flame effect fire, the arrangement including a first track adhesively fixed to fabric, the fabric having a plurality of slits defined therein, the slits forming two or more flag elements within the fabric, wherein the fabric is adhered to a first surface of the track in a first plane and to one or more second surfaces of the track in a second plane.

The assembly may further include a second track adhesively fixed to the fabric the first and second tracks being separated from one another by the fabric. The fabric may be adhered to a first surface of the second track in a first plane and to one or more second surfaces of the second tack in a second plane.

In addition the invention provides a method, flame effect insert and fire substantially as hereinafter described with reference to the accompanying Figures.

The tracks are preferably formed from a metal. Ideally the metal is a light metal which can be formed from for example mild steel which is nickel plated.

Desirably prior to providing a plurality of slits in the fabric inner portions of the individual tracks are punched so as to stand proud of the surface of the tracks. Such a punching of the portions of the track results in a change in orientation of the fabric secured to these portions relative to fabric secured to the main portion of the track. These inner portions of the track are desirably punched or pushed so as to be substantially perpendicular to the main axis of the track.

Once the assembly has been fabricated, individual flag insert arrangements may be formed by cutting the assembly to one or more desired lengths. Each of the flag insert arrangements are dimensioned to fit within a predefined area within an electric fire. Desirably the arrangements are hung within the fire using a first track to secure the arrangement within the fire. The fabric will then hang under the effect of gravity.

These and other features of the invention will be understood with reference to the following drawings.

### BRIEF DESCRIPTION OF THE DRAWINGS

FIG. 1 is a perspective view showing a flag arrangement in accordance with an embodiment of the invention.

FIG. 2 is a isometric view showing a method of assembling such an arrangement.

FIGS. 3A to 3E show the formation of the arrangement during a plurality of individual steps.

FIG. 4 shows an exploded view of a fire configured to receive an assembly in accordance with the invention.

### DETAILED DESCRIPTION OF THE DRAWINGS

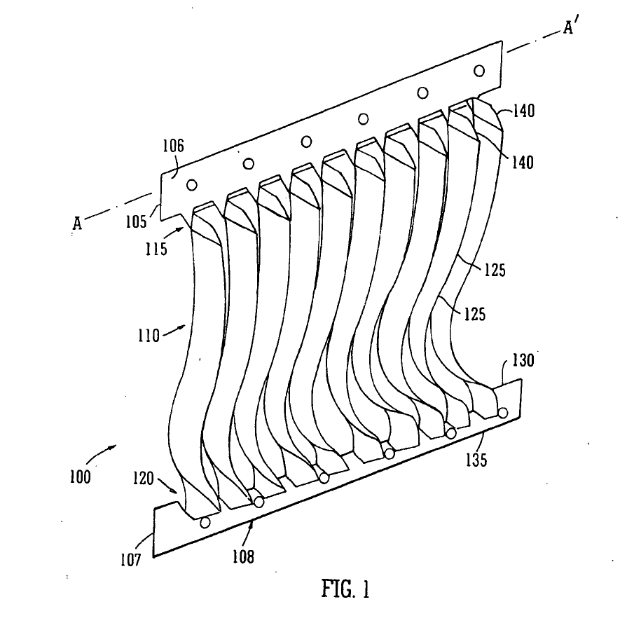

The invention will now be described with reference to FIGS. 1 to 4. As shown in FIG. 1, a flag arrangement 100 is provided which includes a first 105 and second 107 track. The tracks are provided with a first 106 and second surface 108. Each of the tracks are separated by a fabric 110 secured at upper 115 and lower 120 surfaces thereof to the first and second tracks respectively. The fabric is desirably secured to the first surface 106 of each track using an adhesive. The fabric is cut so as to define a plurality of individual flags 125. The cuts are formed in a direction transverse to the main axis A-A′ of the tracks. Despite the plurality of cuts the fabric portion is still one piece, the individual flag elements are attached to one another at upper and lower surfaces.

The tracks have inner 130 (i.e. adjacent to the fabric) and outer 135 (i.e. remote from the fabric) portions. Desirably formed from a metal, a plurality of segments 140 defined in the inner portions are cut and punched so as to stand proud of the first surface 106. The result of this is that the flag elements 125 which are adhered to the segments 140 will also stand proud of the main axis A-A′ of the tracks.

A plurality of index holes 150 are visible on the first and second tracks. These holes are a legacy from the manufacturing process but can be used to secure the arrangement within a fire.

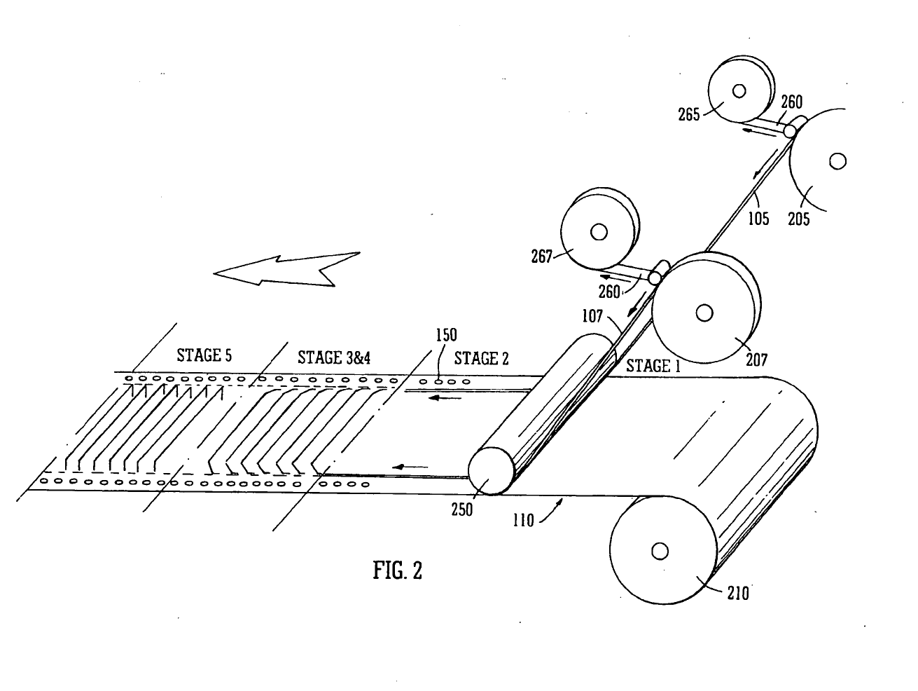

FIG. 2 shows a preferred method of forming such an arrangement which is provided to assist in an understanding of the teaching of the invention. The person skilled in the art will understand that the invention is not intended to be limited in any fashion to the sequence of steps detailed except as may be deemed necessary in the light of the appended claims.

The process of assembly comprises stages as follows:

stage 1—collation, where the component materials are collated and aligned relative to each other; This stage is carried out at a collation station.

stage 2—fixing/adhesion, where the component materials are fixed, in this case by use of adhesive. This stage is carried out at a fixing station.

stages 3 and 4—die cutting/punching, where portions of the track or tracks carrying the fabric are punched through. These stages are carried out at the die cutting/punching station and push through stations.

stage 5—cutting—a two stage process, firstly including the step of cutting slits in the fabric and secondly including the step of cutting through the tracks and fabric to form one or more individual flame effect assemblies. These stages are carried out at first and second cutting stations.

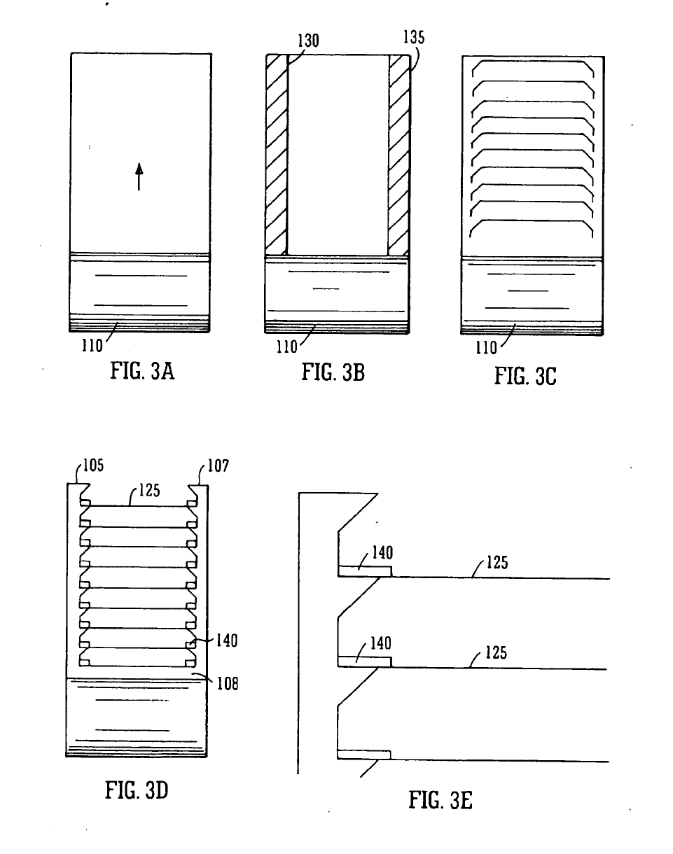

For ease of understanding FIG. 2 will be described with reference to FIG. 3. As shown from right to left of the Figure, in stage 1, two metal coils 205, 207 are arranged above a fabric roll 210 from which a length of fabric 110 can be extended (FIG. 3A). The metal coils are desirably formed from a mild steel which is nickel coated or a hot dip galvanised metal, although as will be appreciated any suitable material can be used for the tracks. The coil is pre-provided with a double sided adhesive tape—one side of which secures the tape to the track and the other side has a protective layer 260 to maintain the adhesive properties during the coiling process. During the uncoiling and straightening of the tracks 105, 107 from their respective coils 205, 207, the protective layer 260 is removed from each of the tracks and coiled onto two waste rollers 265, 267.

The removal of the protective layer results in one side (the first side 106) of each of the tracks having an adhesive layer exposed and this side is then adhered onto the surface of the fabric 110 (FIG. 3B). To ensure adhesion, a roller 250 is provided which in stage 2 applies pressure to the fabric and tracks ensuring good contact and adhesion between the two. The use of the index holes 150 can be used to pull the collated combination of tracks and fabric along the assembly unit (for the sake of convenience the specifics of the collation assembly unit is not described).

The fabric drawn from the roll is fixed to the tracks such that the longitudinal axis of the fabric extends substantially in the same direction as the longitudinal axis of the tracks.

During Stages 3 and 4, once adherence between the fabric and tracks has been achieved, each of the tracks are die cut (FIG. 3C) and inner segments 140 on each track is pushed out at right angles to the direction of collation (FIG. 3D).

The segments 140 are spaced along the longitudinal axis of the track. In this case, the segments are equally spaced along the length of the track. It will be appreciated that the dimensions of the segments 140 and their separation may be varied as required,

These segments 140 have fabric attached thereto and as a result of the formation of these segments there is increased tension in the fabric.

The fabric is therefore cut to form the individual flag elements, shown in detailed section in FIG. 3E.

At this stage, stage 5, the arrangement is cut using a guillotine or some other suitable cutting device at desired distances across the tracks so as to form individual assemblies which can then be hung on suitable rails within a fire.

The flame effect assembly is preferably formed in an in-line process, and most preferably in a continuous in-line process. A detection and/or monitoring and/or feedback means may be provided located at one or more points on the production line, such means being operable to ensure correct alignment of the component materials at each stage.

After the selected segments 140 have been die cut/punched and pushed through the net effect is that the fabric is adhered to a first surface of each of the tracks in a first plane and to one or more second surfaces of the tracks in a second plane. In the embodiment illustrated, the first and second planes are substantially perpendicular to one another, the slits being defined at locations coincident with the location of the second surfaces.

In this case the fabric is attached between two tracks, the segments directly opposite each other on the first and second tracks are of similar form and final orientation. It will be understood that the dimensions and form of the segments cut in the track may be varied. Similarly the degree to which the inner segments are pushed through to protrude or stand proud of the main axis may be varied. As a result, the orientation of any segment relative to the main axis of the tracks may be varied. The step of die cutting/punching the inner segments and pushing through to protrude relative to the main axis of the track provides for the introduction of a depth dimension to the flame effect assembly.

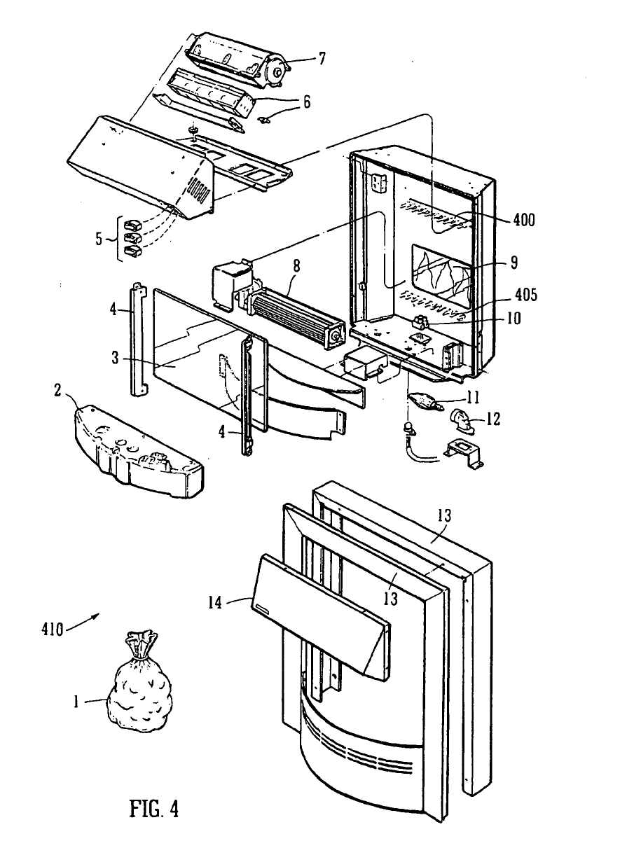

FIG. 4 shows an example, in exploded view of such a fire 410 that may be used in combination with the assembly. In this view certain elements are identifiable including in numerically identified order, some artificial fuel elements 1, a fuel bed 2, a glass screen 3 which is desirably provided with a partially reflective inner surface and which is mounted within the fire using two vertical support struts 4. Individual switches 5 are coupled to a fan heater 6, 7 that is mounted in an upper area of the fire. A rotary blower 8 is mounted in a lower portion of the fire below a reflective screen 9 that has some images of flames provided thereon. A lighting arrangement 10, 11, 12 is provided adjacent to the blower 8 and illuminates the screen 9 above. Two mounting brackets 400, 405 are provided above and below the reflective screen and are configured to couple with the tracks 106, 107 of the flame effect assembly. The distance between the two tracks is desirably such that the fabric is not stretched or taut but that some slack or sag is left in the fabric. Once mounted, the flame effect assembly will be in front of the reflector and the action of the blower below the assembly will cause movement of the individual flag elements. In contrast to the prior art arrangements where individual flags were mounted separately, which is obviously a time consuming exercise, using an assembly in accordance with the teachings of the invention the entire assembly is prefabricated as a single unit and then simply mounted quickly within the fire. Once all internal elements have been mounted it is then possible to apply the front covers 13 and hood 14.

It will be appreciated that the final orientation of the segments 140 relative to the tracks may be varied, to produce a desired net effect. Variation in orientation of the punched though segments relative to the main axis of the tracks will result in variation in tension in the fabric. It will also result in variation of the final visual effects.

It will be appreciated that what has been described herein is a flag assembly that is formed as a single integer and can then be hung within a fire in a simple one step process. The invention has been described with reference to preferred embodiments where the fabric is adhered to two tracks, top and bottom. It will be understood that certain arrangements may consider the use of a single track. For example the fabric could be adhered at an upper surface to a track and then hung under the effects of gravity over an air blower to achieve the necessary movement. In such a circumstance the output of the blower may have to be reduced below that which is normally considered appropriate for such effects so as to ensure that the individual elements of the assembly are not blown upward and above the reflector screen, thereby removing them from the viewer in front of the fire. In an alternative embodiment, but again where the assembly is adhered at one side only to a track, the track is bottom mounted such that active blowing from below is required to force the flag elements to rise above the track and billow in front of the reflector. In the embodiments the arrangement of segments on first and second tracks is substantially the same. However, it will be appreciated that depending on the flame effect assembly requirements, segments may be arranged in various ways for example they may be punched and pushed through on one of the tracks only or for example, they may be pushed through in opposite directions on the first and second tracks. Similarly it will be appreciated that within a single production run the orientation of segments may be varied from a first to a second end of the flame effect assembly so that for example, some of the segments are arranged substantially at right angles to the main axis of the tracks and some at other different orientations. Again the process of the invention advantageously would allow for such arrangements to be produced in an efficient and reproducible manner.

These and other modifications will be apparent to the person skilled in the art and therefore although the invention is described with reference to one embodiment thereof it is intended that it be limited only insofar as is required in the light of the appended claims.

The process of the invention provides for the step of die-cutting/punching or pushing tracks so as to form portions of the tracks/segments which protrude/stand proud of the surface of the tracks. Thus the process has the advantage of enabling alternative arrangements of the flag elements within the flame effect assembly, as required.

The process has the further advantage of being flexible; for example, the orientation of the segments may be set and varied, as required, with ease. The process of the invention also has the advantage that it provides an efficient process for providing within a single integral unit a flame effect assembly with flag elements supported on the segments in different planes and thus provides a three-dimensional arrangement within the flame effect assembly.

Advantageously the three-dimensional arrangement of flag elements is integral to the flame effect assembly and not dependent on how parts of the assembly, or the assembly, is mounted within the heater.

The flag element arrangement produced by the process of the invention, has the advantage of high levels of reproducibility. This is in contrast to prior art approaches in which different arrangements of flag elements were produced for example by hanging vertical ribbons with alternate ribbons off-set forward of adjacent ribbons such that they overlap, which in comparison with the process of the invention is a skilled and time-consuming operation.

The process of the invention has the advantage that it is highly efficient. There is a resultant improvement in the rate of production and a reduction in waste of materials.

The words comprises/comprising when used in this specification are to specify the presence of stated features, integers, steps or components but does not preclude the presence or addition of one or more other features, integers, steps, components or groups thereof.

1. A method of manufacturing a flag assembly for use in an electric fire, the method comprising:
providing a roll of fabric,
providing a first track,
attaching a portion of the fabric to the first track so as to fix the fabric to the track, and
providing a plurality of slits in the adhered fabric, the plurality of slits defining a plurality of flag elements.

2. The method as claimed in claim 1 wherein the providing the first track includes providing a second track, and wherein the attachment of the fabric fixes the fabric to the first and second tracks such that the fabric is fixed to and separates the first and second tracks.

3. The method as claimed in claim 2 wherein the attachment of the fabric to the respective tracks is effected by providing an adhesive surface on a first surface of each of the tracks and applying that adhesive surface onto the fabric so as to secure the fabric onto the tracks.

4. The method as claimed in claim 2 wherein the tracks are initially provided as two individual coils that are unwound at an unwind station to provide respective tracks during the collation process.

5. The method as claimed in claim 4 wherein the adhesive surface is provided by applying an adhesive tape prior to forming the coil, the tape having a protective cover on an outermost surface which is removed during the uncoiling of the track from the coil.

6. The method as claimed in claim 4 wherein an adhesive is applied to the individual tracks during the uncoiling process.

7. The method as claimed in claim 2 wherein the tracks are formed from a metal, such as nickel plated mild steel.

8. The method as claimed in claim 1 further comprising the punching of segments of the individual tracks so as to form punched segments of the tracks which stand proud of the surface of the tracks.

9. The method as claimed in claim 8 wherein the orientation of the fabric of said segments is changed relative to the surface of the tracks.

10. The method as claimed in claim 8 wherein the segments of the track are punched or pushed so as to be substantially perpendicular to the main axis of the track.

11. The method as claimed in claim 1 wherein once an assembly has been fabricated, individual flag inserts may be formed by cutting the assembly to one or more desired lengths.

12. The method as claimed in claim 11 wherein each of the flag inserts are dimensioned to fit within a predefined area within an electric fire.

13. The method as claimed in claim 11 wherein the inserts are hung within the fire using a first track to secure the insert within the fire.

14. The method as claimed in claim 1 wherein the flag assembly in manufactured in an in-line process.

15. A flag assembly for use in a flame effect fire, comprising fabric fixed at one end to a track to define a first portion of fabric fixed to the track, and a second portion of fabric depending from the track, wherein the second portion of fabric is cut to define a plurality of slits therein, the slits forming two or more flag elements within the fabric.

16. The assembly as claimed in claim 15 wherein the fabric is fixed to a first surface of the track in a first plane and one or more second surfaces of the track in a second plane.

17. The assembly as claimed in claim 15 further including a second track fixed to the fabric, the first and second tracks being separated from one another by the fabric.

18. The assembly as claimed in claim 17 wherein the fabric is affixed to a first surface of the second track in a first plane and one or more second surfaces of the second track in a second plane.

19. The assembly as claimed in claim 16 wherein the first and second planes are substantially perpendicular to one another.

20. The assembly as claimed in claim 16 the slits being defined at locations coincident with the location of the second surfaces.

21. The assembly as claimed in claim 16 wherein the second surface comprises a segment of the track which is punched or pushed to stand proud of the main axis of the track.

22. The assembly as claimed in claim 16 wherein the second surfaces are spaced apart along the longitudinal axis of the track.

23. The assembly as claimed in claim 16 wherein second surfaces on the first and second tracks are oppositely located.

24. The assembly as claimed in claim 15 wherein the fabric comprises a continuous length of fabric.

25. (canceled)

26. The assembly as claimed in claim 15 wherein the fabric is fixed to the track at a longitudinal side edge thereof.

27. The assembly as claimed in claim 15 wherein the longitudinal axis of the fabric runs substantially parallel to the longitudinal axis of the track to which it is fixed.

28. A flag assembly for use in a flame effect fire, the arrangement including a first track fixed to fabric, the fabric having a plurality of slits defined therein, the slits forming two or more flag elements within the fabric, wherein the fabric is fixed to a first surface of the track in a first plane and to one or more second surfaces of the track in a second plane.

29. The assembly as claimed in claim 28 further including a second track fixed to the fabric the first and second tracks being separated from one another by the fabric.

30. The assembly as claimed in claim 28 wherein the fabric is adhesively fixed or adhered to a first surface of the second track in a first plane and to one or more second surfaces of the second tack in a second plane.

31. An electric fire including a flag assembly as claimed in claim 15.

32-33. (canceled)
